(19) United States
(12) Patent Application Publication
(10) Pub. No.: US 2018/0107324 A1
(43) Pub. Date: Apr. 19, 2018

(54) Touch Display Substrate, Touch Display Panel and Manufacturing Method of Touch Display Substrate

(71) Applicants: BOE Technology Group Co., Ltd., Beijing (CN); Beijing BOE Optoelectronics Technology Co., Ltd., Beijing (CN)

(72) Inventors: Xiaoliang Ding, Beijing (CN); Xue Dong, Beijing (CN); Haisheng Wang, Beijing (CN); Xiaochuan Chen, Beijing (CN); Yingming Liu, Beijing (CN); Shengji Yang, Beijing (CN); Wei Liu, Beijing (CN); Pengpeng Wang, Beijing (CN); Changfeng Li, Beijing (CN)

(73) Assignees: BOE Technology Group Co., Ltd., Beijing (CN); Beijing BOE Optoelectronics Technology Co., Ltd., Beijing (CN)

(21) Appl. No.: 15/540,221

(22) PCT Filed: Jun. 1, 2016
(86) PCT No.: PCT/CN2016/084303

§ 371 Date: Jun. 27, 2017

(30) Foreign Application Priority Data
Feb. 25, 2016 (CN) 201610105230.3

(51) Int. Cl. G06F 3/041; G02F 1/1333; G02F 1/1343; G01L 1/16

(52) U.S. Cl. CPC G06F 3/0414; G02F 1/13338; G06F 2203/04103; G01L 1/16; G02F 1/1343

(57) ABSTRACT

A touch display substrate includes: a transparent base; a transparent back electrode layer positioned on a front side of the transparent base; a plurality of piezoelectric detection units positioned on a front side of the transparent back electrode layer and arranged in an array; wherein each of the piezoelectric detection units includes a pressure sensitive material layer and a transparent detecting electrode layer sequentially disposed on the front side of the transparent back electrode layer. The touch display substrate further includes a plurality of signal leads, and the respective transparent detecting electrode layer connected with a corresponding one of the plurality of signal leads. A touch display panel and a method of manufacturing the touch display substrate are further disclosed.

### TECHNICAL FIELD

At least one embodiment of the present disclosure relates to a touch display substrate, a touch display panel and a manufacturing method of touch display substrate.

### BACKGROUND

With the rapid development of display technology, touch display panels have gradually spread throughout people's lives. At present, in accordance with the operation principles, the touch display panel can be divided into: resistive type, capacitive type, infrared type, surface acoustic wave type, electromagnetic type, vibration induction type, frustrated total internal reflection optical induction type and etc. Among these touch display panels, capacitive type touch display panel has been paid widespread attention due to its unique touch principle and advantages of high sensitivity, long life and high transmittance and the like.

The mutual capacitive type touch display panel comprises a set of driving electrode lines and a set of detecting electrode lines which are intersected with and insulated from each other. The driving electrode lines and the detecting electrode lines are electrically connected to a flexible printed circuit board respectively through electrode wirings. The operation principle is as follows. When a finger touches the panel, mutual capacitance between the driving electrode line and the detecting electrode line is changed. Driving electrode lines oriented in the X-direction are scanned one by one, and a signal of the respective detecting electrodes oriented in Y-direction is read when each driving electrode line is scanned. Through a round of scanning, each of the intersections between the driving electrode lines and the detecting electrode lines are scanned, so that the intersection at which the mutual capacitance changes can be determined, and thus the coordinates of the touch point can be determined. And then, a touch display based on the coordinates of the touch point is achieved.

At present, most of the touch display panels cannot sense the magnitude of the touch pressure, which restricts the touch interactive function of the product, and thus a higher level of user experience cannot be obtained.

### SUMMARY

At least one embodiment of the present disclosure provide a touch display substrate, comprising:

a transparent base,

a transparent back electrode layer positioned on a front side of the transparent base;

a plurality of piezoelectric detection units positioned on a front side of the transparent back electrode layer and arranged in an array, and a plurality of signal leads respective of which corresponds to the respective piezoelectric detection units, each of the piezoelectric detection units comprising a pressure sensitive material layer and a transparent detecting electrode layer sequentially disposed on the front side of the transparent back electrode layer, and the respective transparent detecting electrode layer connected with a corresponding one of the plurality of signal leads.

At least one embodiment of the present disclosure provides a touch display panel, comprising the touch display substrate mentioned above.

At least one embodiment of the present disclosure provides a manufacturing method of touch display substrate, comprising:

forming a transparent back electrode layer on a front side of the transparent base substrate; and

forming a plurality of piezoelectric detection units arranged in an array on a front side of the transparent back electrode layer and a plurality of signal leads, each of which is connected with a corresponding one of the transparent detecting electrode layer, each of the piezoelectric detection units comprising a pressure sensitive material layer and a transparent detecting electrode layer sequentially arranged on the front side of the transparent back electrode layer.

### BRIEF DESCRIPTION OF THE DRAWINGS

In order to clearly illustrate the technical solutions of the embodiments of the disclosure, the drawings of the embodiments will be briefly described in the following; it is obvious that the drawings described below are only related to some embodiments of the disclosure and thus are not limitative of the disclosure.

FIG. 1 is an illustrative view of a touch structure of a touch display substrate according to a first embodiment of the present disclosure;

FIG. 2 is an illustrative top structural view of a touch display substrate according to a second embodiment of the present disclosure;

FIG. 3 is an illustrative cross-sectional structural view of the touch display substrate according to a second embodiment of the present disclosure;

FIG. 4 is an illustrative top structural view of a touch display substrate according to a third embodiment of the present disclosure;

FIG. 5 is an illustrative cross-sectional structural view of the touch display substrate according to a third embodiment of the present disclosure;

FIG. 6 is a diagram of the detection principle of the piezoelectric detection unit; and

FIG. 7 is an illustrative flow chart of a manufacturing method of the touch display substrate according to the embodiments of the present disclosure.

### REFERENCE SIGNS

1—transparent base; 2—transparent back electrode layer; 3—piezoelectric detection unit; 4—signal lead; 5—planarization layer; 6—transparent cover plate; 7—shielding matrix; 31—pressure sensitive material layer; 32—transparent detecting electrode layer; 51—insulating layer; 52—transparent optical glue; 100—color filter substrate.

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

In order to enrich the touch interactive function of the touch display panel and allow the user to have a higher level of operation experience, embodiments of the present disclosure provide a touch display substrate, a touch display panel comprising the touch display panel and a manufacturing method of the touch display substrate.

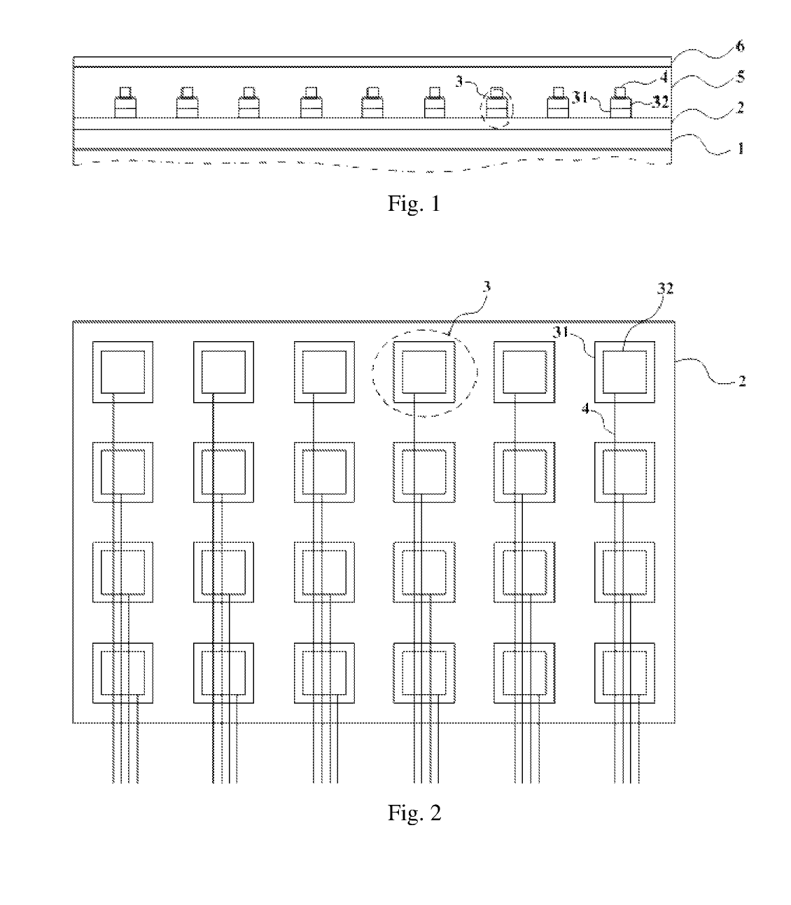

As illustrated in FIG. 1, at least one embodiment of the present disclosure provides a touch display substrate, comprising:

a transparent base 1;

a transparent back electrode layer 2 disposed on the front side of the transparent base 1;

a plurality of piezoelectric detection units 3 disposed on the front side of the transparent back electrode layer 2 and arranged in an array, and respective signals leads 4 corresponding to each of the piezoelectric detection units 3, each of the piezoelectric detection units 3 comprising a pressure sensitive material layer 31 and a transparent detecting electrode layer 32 sequentially disposed on the transparent back electrode layer 2, the respective transparent detecting electrode layers 32 being connected with a corresponding signal lead 4.

In addition, the touch display substrate further comprises a planarization layer 5 disposed on the plurality of piezoelectric detection units 3 and a transparent cover plate 6 positioned on the planarization layer 5.

In the embodiments of the present disclosure, the term of “front side” can be understood to be a side of the touch display panel close to the user when the component is in use. Accordingly, a side of the part away from the user can be understood to be “back side”.

By use of the structure of the embodiment as illustrated in FIG. 1, when the transparent cover plate 6 is pressed, the pressure sensitive material layer 31 is pressurized to generate a polarized charge and the potential of the transparent detecting electrode layer 32 is changed and thus the potential difference between the transparent detecting electrode layer 32 and the transparent back electrode layer 2 is changed. Therefore, the pressing pressure can be calculated by obtaining the potential of the transparent detecting electrode layer 32 (the detecting principle of the piezoelectric detection unit is illustrated in FIG. 6). Based on this principle, a touch display panel having a pressure detecting function can be developed, thereby enriching the touch interactive function of the touch display panel and enabling a higher level of operation experience for the user.

For example, the user can apply different pressures to a screen of the touch display panel with a finger or a stylus to achieve operations such as variable speed scrolling, zoom and pan of pictures, preview and selection of functions, continuously variable game control, unlocking a function and waking up a function, opening the context menu, drawing brush thickness selection, image editing, capital locking and symbol selection and the like.

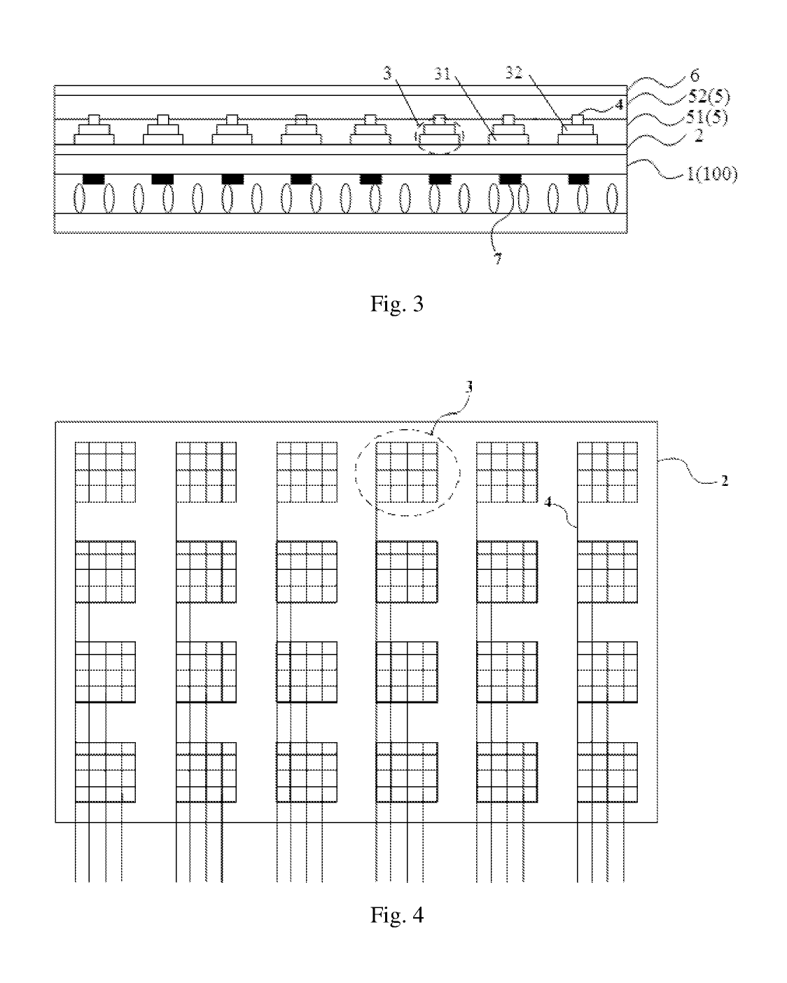

In the embodiments of the present disclosure, the transparent base 1 is the base for the front substrate of display module. For example, as illustrated in FIG. 3, the transparent base 1 can be the transparent base 1 of the color filter substrate 100 of the liquid crystal display module. The transparent back electrode layer 2 is provided on the front side of the transparent base 1 and can be connected to a fixed potential. For example, the transparent back electrode layer 2 is grounded, so that the potential of the transparent detecting electrode layer 32 is the potential generated by the pressing, and thus the detection and the calculation can be made more simple and convenient.

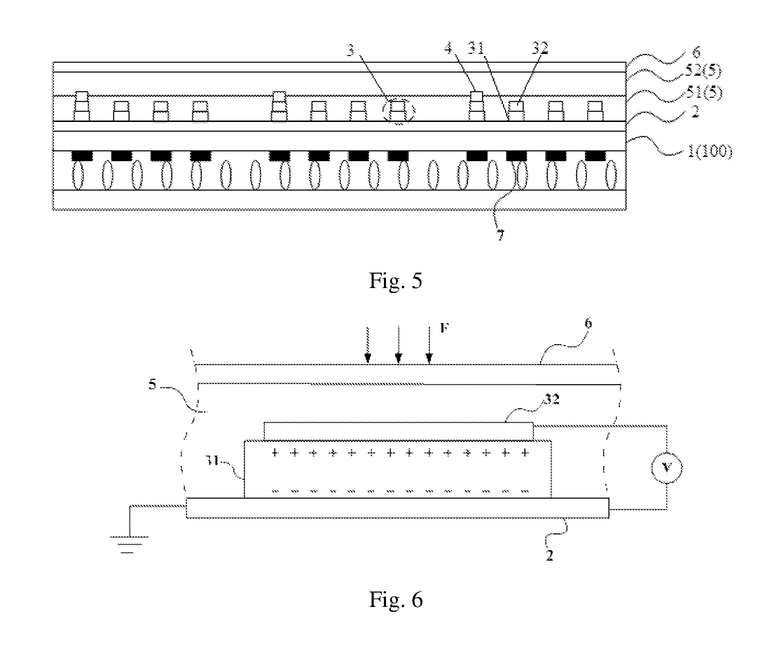

In one embodiment of the present disclosure, the transparent back electrode layer 2 and the transparent detecting electrode layer 32 can be formed of a transparent conductive material such as indium tin oxide (ITO) and zinc oxide (ZnO). The material of the pressure sensitive material layer 31 is not limited, and can be formed of polymer pressure sensitive material, composite pressure sensitive material of metal and polymer, or oxide pressure sensitive material and etc. The structure of the planarization layer 5 is not limited. As illustrated in FIG. 3 and FIG. 5, the planarization layer 5 comprises an insulating layer 51 disposed on the front side of the plurality of piezoelectric detection units 3 and a transparent optical glue layer 52 disposed on the front side of the insulating layer 51.

As illustrated in FIG. 2 and FIG. 3, in this embodiment, the transparent base 1 is the transparent base of the color filter substrate 100. The touch display substrate further comprises a shielding matrix 7 disposed on the back side of the transparent base 1. The projection of the signal leads 4 on the transparent base 1 falls within the projection of the shielding area of the shielding matrix 7 on the transparent base 1. Since the signal leads 4 and the shielding matrix 7 are arranged opposite, arrangement of the signal leads 4 would not affect the pixel aperture ratio and the display effect is good.

In the present embodiment, the pressure sensitive material layer 31 and the transparent detecting electrode layer 32 are block-shaped respectively, and the signal leads 4 and the shielding matrix 7 of the color filter substrate 100 are disposed opposite. When the transmittance of the pressure sensitive material layer 31 is high, such a structural design can be used. It is to be noted that the shapes of the pressure sensitive material layer 31 and the transparent detecting electrode layer 32 are not limited, and can be of a square shape as illustrated, or can be of a patterned shape such as circular, triangular, polygonal, or the like.

Further, the orthographic projection of the profile of the transparent detecting electrode layer 32 on the plane where the pressure sensitive material layer 31 lies falls within the profile of the pressure sensitive material layer 31. Thus, the transparent detecting electrode layer 32 and the transparent back electrode layer 2 can be isolated sufficiently, thereby ensuring the potential difference between the transparent detecting electrode layer 32 and the transparent back electrode layer 2 and thus guaranteeing reliability of circuit.

As illustrated in FIG. 4 and FIG. 5, in this embodiment, the transparent base 1 is the transparent base of the color filter substrate 100. The piezoelectric detection units 3 are mesh-shaped. The projection of the physical structure of the signal leads 4 and the piezoelectric detection units 3 on the transparent base 1 falls within the projection of the shielding area of the shielding matrix 7 on the transparent base 1. That is to say, the pressure sensitive material layer 31 and the transparent detecting electrode layer 32 are both mesh-shaped and have their physical structures laminated. The physical structure is defined relative to the hollow areas. When the transmittance of the pressure sensitive material layer 31 is low, such a structural design can be used. Since the physical structures of the signal leads 4 and the piezoelectric detection units 3 are both positioned opposite to the shielding matrix 7 of the color filter substrate 100, the pixel aperture ratio will not be affected, so that a good display effect can be achieved.

At least one embodiment of the present disclosure further provides a touch display panel comprising the above-described touch display substrate. The touch display panel can sense the magnitude of touch pressure, based on which touch interactive functions of the touch display panel can be enriched, and thus the user can have a higher level of operation experience. The touch display panel can be applied to products which are not limited to a tablet computer, a cell phone, a touch display platform and the like.

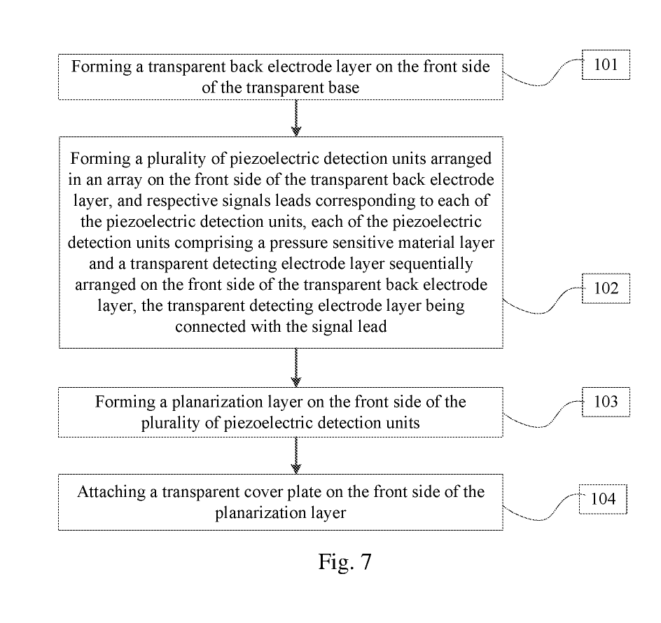

As illustrated in FIG. 7, at least one embodiment of the present disclosure further provides a manufacturing method of touch display substrate, comprising:

forming a transparent back electrode layer on the front side of the transparent base; and

forming a plurality of piezoelectric detection units arranged in an array on the front side of the transparent back electrode layer, and respective signals leads corresponding to each of the piezoelectric detection units, each of the piezoelectric detection units comprising a pressure sensitive material layer and a transparent detecting electrode layer sequentially arranged on the front side of the transparent back electrode layer, the transparent detecting electrode layer being connected with the signal lead.

In one embodiment of the present disclosure, the manufacturing method further comprises forming a plurality of signal leads each of which is connected with the corresponding transparent detecting electrode layer.

In addition, in one embodiment of the present disclosure, the manufacturing method further comprises:

forming a planarization layer on the front side of the plurality of piezoelectric detection units; and

attaching a transparent cover plate on the front side of the planarization layer.

In one embodiment of the present disclosure, the transparent base is a transparent base substrate of a color filter substrate. The pressure sensitive material layer and the transparent detecting electrode layer are block-shaped respectively. The orthographic projection of the signal leads on the transparent base substrate falls within the orthographic projection of the shading area of the shielding matrix on the transparent base substrate.

In one embodiment of the present disclosure, the transparent base is a transparent base substrate of a color filter substrate. The piezoelectric detection units are distributed in a grid-like manner. The orthographic projection of the physical structure of the signal leads and the piezoelectric detection units on a plane where the shielding matrix is located falls within the orthographic projection of the shading area of the shielding matrix.

When the touch display substrate manufactured by the method according to the embodiments of the present disclosure is applied to a touch display panel, the touch display panel can sense the magnitude of touch pressure, based on which the touch interactive function of the touch display panel can be enriched, and thus the user can have a higher level of operation experience.

The foregoing are merely exemplary embodiments of the disclosure, but are not used to limit the protection scope of the disclosure. The protection scope of the disclosure shall be defined by the attached claims.

The present disclosure claims priority of Chinese Patent Application No. 201610105230.3 filed on Feb. 25, 2016, the disclosure of which is hereby entirely incorporated by reference as a part of the present disclosure.

1. A touch display substrate, comprising:
a transparent base;
a transparent back electrode layer positioned on a front side of the transparent base;
a plurality of piezoelectric detection units positioned on a front side of the transparent back electrode layer and arranged in an array;
wherein each of the piezoelectric detection units comprises a pressure sensitive material layer and a transparent detecting electrode layer sequentially disposed on the front side of the transparent back electrode layer.

2. The touch display substrate according to claim 1, further comprising a plurality of signal leads, and the respective transparent detecting electrode layer is connected with a corresponding one of the plurality of signal leads.

3. The touch display substrate according to claim 2, further comprising a shielding matrix positioned on a back side of the transparent base, and an orthographic projection of the signal leads on the transparent base falls within an orthographic projection of the shading area of the shielding matrix on the transparent base.

4. The touch display substrate according to claim 1, wherein the pressure sensitive material layer and the transparent detecting electrode layer are block-shaped respectively.

5. The touch display substrate according to claim 1, wherein an orthographic projection of a contour edge of the transparent detecting electrode layer on the transparent base falls within an orthographic projection of a contour edge of the pressure sensitive material layer on the transparent base.

6. The touch display substrate according to claim 3, wherein the piezoelectric detection units are arranged in a grid-like manner, and an orthographic projection of a physical structure of the piezoelectric detection units on the transparent base falls within the orthographic projection of the shading area of the shielding matrix on the base.

7. The touch display substrate according to claim 6, wherein the transparent back electrode layer is grounded.

8. The touch display substrate according to claim 1, further comprising a planarization layer positioned on a front side of the plurality of piezoelectric detection units.

9. The touch display substrate according to claim 8, further comprising a transparent cover plate positioned on a front side of the planarization layer.

10. The touch display substrate according to claim 8 wherein the planarization layer comprises an insulating layer positioned on the front side of the plurality of piezoelectric detection units and a transparent optical glue layer positioned on a front side of the insulating layer.

11. A touch display panel, comprising the touch display substrate according to claim 1.

12. A manufacturing method of touch display substrate, comprising:
forming a transparent back electrode layer on a front side of the transparent base; and
forming a plurality of piezoelectric detection units arranged in an array on a front side of the transparent back electrode layer, each of the piezoelectric detection units comprising a pressure sensitive material layer and a transparent detecting electrode layer sequentially arranged on the front side of the transparent back electrode layer.

13. The manufacturing method according to claim 12, further comprising forming a plurality of signal leads, each of which is connected with a corresponding one of the transparent detecting electrode layer.

14. The manufacturing method according to claim 12, further comprising:
forming a planarization layer on a front side of the plurality of piezoelectric detection units; and
attaching a transparent cover plate on a front side of the planarization layer.

15. The manufacturing method according to claim 13, wherein
the transparent base is a transparent base substrate of a color filter substrate, a shielding matrix is formed on a back side of the transparent base substrate, the pressure sensitive material layer and the transparent detecting electrode layer are block-shaped respectively, and an orthographic projection of the signal leads on the transparent base substrate falls within an orthographic projection of a shading area of the shielding matrix on the transparent base substrate.

16. The manufacturing method according to claim 13, wherein
the transparent base is a transparent base substrate of a color filter substrate, a shielding matrix is formed on a back side of the transparent base substrate, the piezoelectric detection units are arranged in a grid-like manner, an orthographic projection of a physical structure of the signal leads and the piezoelectric detection units on the transparent base substrate falls within an orthographic projection of a shading area of the shielding matrix on the transparent base substrate.

17. The touch display substrate according to claim 2, wherein the pressure sensitive material layer and the transparent detecting electrode layer are block-shaped respectively.

18. The touch display substrate according to claim 3, wherein the pressure sensitive material layer and the transparent detecting electrode layer are block-shaped respectively.

19. The touch display substrate according to claim 2, wherein an orthographic projection of a contour edge of the transparent detecting electrode layer on the transparent base falls within an orthographic projection of a contour edge of the pressure sensitive material layer on the transparent base.

20. The touch display substrate according to claim 3, wherein an orthographic projection of a contour edge of the transparent detecting electrode layer on the transparent base falls within an orthographic projection of a contour edge of the pressure sensitive material layer on the transparent base.
